(19) United States
(12) Patent Application Publication
(10) Pub. No.: US 2007/0263004 A1
(43) Pub. Date: Nov. 15, 2007

(54) Plug-in graphics module architecture

(75) Inventor: Min-Chuan Wan, Hsinchu City (TW)

Correspondence Address: John Chen, Room303, 3F., No 25, Sec. 1, Changan E. Road, Taipei, 10441, TW

(73) Assignee: XGI Technology Inc., Hsinchu City (TW)

(21) Appl. No.: 11/432,514

(22) Filed: May 12, 2006

(51) Int. Cl. G06T 1/20

(52) U.S. Cl. 345/506

(57) ABSTRACT

The present invention provides an architecture for a plug-in graphics module, comprising the first graphics processing unit (GPU) couples to a low voltage differential signaling (LVDS) channel, the graphics module electrically connected to a north bridge and the GPU. The bridge circuit is capable of transmitting a plurality of data to the graphics module, receiving a processed result from the graphics module, and transmitting the processed result to the memory device for the GPU to access the processed result, and then the GPU outputs the processed result to a panel through the differential signal bus when the graphics module is plugged in the connecter.

### BACKGROUND OF THE PRESENT INVENTION

1. Field of Invention

The invention relates to system with a graphics processing unit, and more particularly to a system with a changeable graphics processing unit.

2. Description of Related Arts

Referring to the FIG. 1, it illustrates a conventional way for a computing system, like a desktop, to improve the performance of the graphics processing. The north bridge 101, an interface to access CPU, transmits the graphics data to the graphics processing units (GPUs) 102 and 103. There are two GPUs 102 and 103 to process the graphics data simultaneously. Obviously, the performance of the multi-GPU system should be better than the uni-GPU system. The processed graphics data are displayed on a display 105.

The above architecture is employed by both of the Nvidia SLI and ATi CrossFire architectures. Both of the GPUs have to come from the same brand and even be limited to some special GPU products. In addition, the architecture only works under a few specific north bridges, such as Nvidia Geforce 6800 on its SLI bridge circuit, and the extra cable line, connector, or converting chip may be necessary.

Next, referring to FIG. 2, it illustrates another conventional way for a portable computing system, like a notebook, to improve the performance of graphics processing. The GPU 202 is the original graphics processing device of a notebook with a poorer performance. The LVDS channel 207 coupled to the GPU 202 is the path for the GPU 202 to transmit the graphics data to an LVDS panel. The GPU 202 may be integrated in the north bridge 201 or a discrete device apart from the north bridge 201.

The graphics module 203 is a changeable device. When the graphics module 203, comprising a GPU (not shown) with better performance, is plugged in the connecter 206, the LVDS channel 207 is off, the GPU 202 does not receive the graphics data from the north bridge, and the graphics memory, like a shared memory in the main memory for the IGP or a local frame buffer (not shown) for a discreet GPU, for the GPU 202 does not work. And then the VBIOS for the GPU 202, stored in Flash, EEPROM or the other storage device (not shown), for the graphics processing unit is not effective any more. The north bridge 201 transmits the graphics data to the graphics module 203 to process through the connecter 206. The processed graphics data are transmitted to the LVDS panel 205 to display through the connecter 206 and the LVDS channel 204.

Both of the Nvidia MXM and ATi AXIOM platforms employ the above architecture. Because the LVDS panel needs to be adjusted via the VBIOS for the correct timing and resolution, the VBIOS for the GPU in the graphics module 203 has to be adjusted and refreshed. It needs special software, the panel information, and an experienced specialist. Even so, it still has to take a long time, maybe a week, to do the adjusting job. For the ordinary users, it is almost a mission impossible to add the extra graphics module 203 by themselves.

Therefore, there is a need to provide a flexible architecture for the users to have another choice to improve the performance of the graphics processing without worrying the problem of purchasing the brand or part number of the GPUs and bridge circuit, adjusting the VBIOS, and buying extra hardware.

### SUMMARY OF THE PRESENT INVENTION

A main object of the present invention is to provide an architecture to improve the performance of the graphics processing of an LVDS system without adjusting the VBIOS.

Another object of the present invention is to provide an architecture to improve the performance of the graphics processing of an LVDS system without worrying the brand and part number of the GPUs and bridge circuit and extra hardware.

Another object of the present invention is to provide an architecture to improve the performance of the graphics processing of an LVDS system by users themselves.

Accordingly, in order to accomplish the one or some or all above objects, the architecture comprises a connecter, and a GPU coupled to an LVDS channel and north bridge. When a graphics module is plugged in the connecter, the graphics module is electrically connected to the north bridge through the connecter. Therefore, the graphics module may receive the data from a north bridge through the connecter. The graphics module processes the data and then transmitted the processed data to a template memory, such a frame buffer of a GPU or a main memory. The GPU gets the processed data from the template memory and then displays it into a LVDS panel by passing through original LVDS channel.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 illustrates a conventional way for a computing system to improve the performance of the graphics processing.

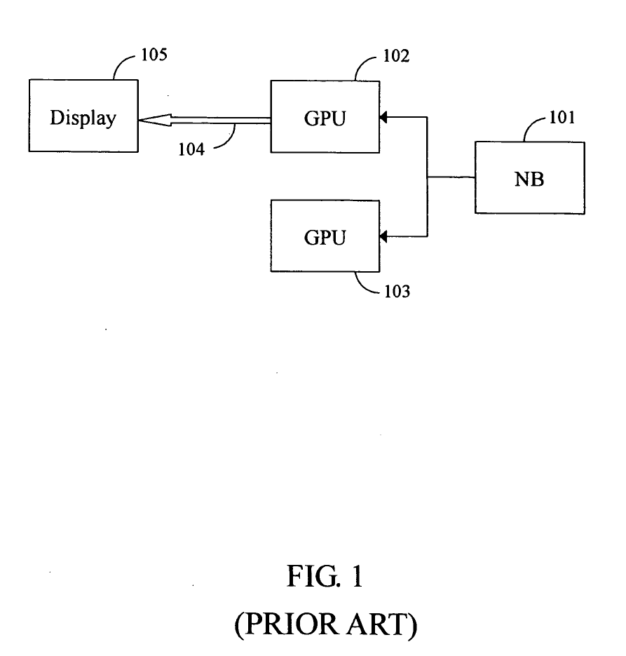

FIG. 2 illustrates another conventional way for a notebook to improve the performance of the graphics processing.

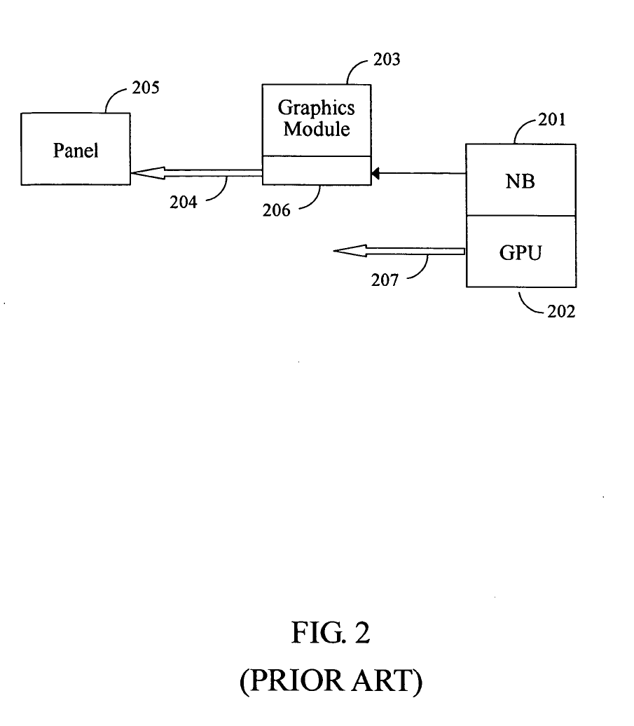

FIG. 3 illustrates a block diagram in accordance with the present invention.

FIG. 4 illustrates the flow chart for processing data in accordance with the present invention.

### DETAILED DESCRIPTION OF THE PREFERRED EMBODIMENT

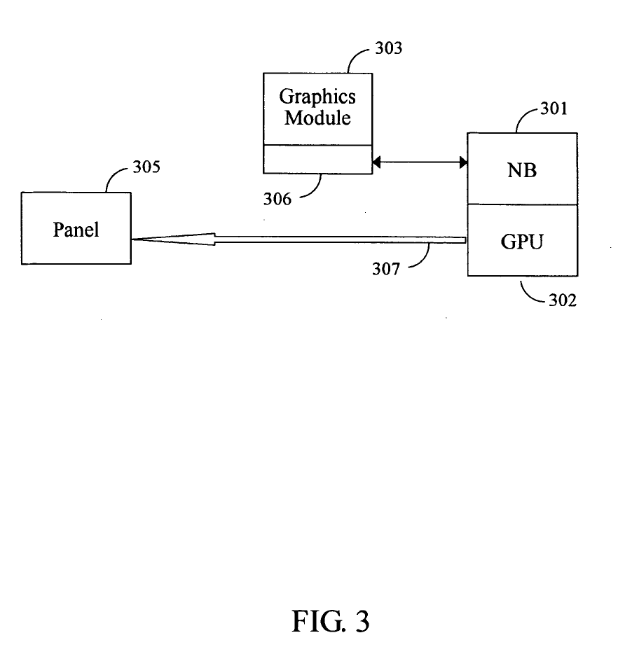

In an embodiment, referring to FIG. 3, it is a block diagram in accordance with the present invention. The north bridge 301 is a part of a bridge circuit (not shown) to access CPU (not shown) of the computing system 300. The GPU 302 is integrated in the north bridge 301. Or in another embodiment, the GPU 302 is a discrete GPU separate device from the north bridge 301. No matter integrated in or separate from the north bridge 301, the GPU 302 comprises the LVDS channel 307 as an output to LVDS panel 305. A storage device (not shown), such as a Flash, EEPROM, is reserved for the VBIOS. The VBIOS for the GPU 302 controls the GPU 302 and the LVDS panel 305 connected to the LVDS channel 307, and also stores the relevant information of the LVDS panel 305.

The graphics module 303 comprising a GPU (not shown) is a changeable device. The graphics module may also comprise a frame buffer and a storage device for the VBIOS of the graphics module. The connecter 306 is electrically connected to the north bridge 301. The graphics module 303 is plugged in the connecter 306, the GPU 302 does not receive the graphics data coming from the north bridge 301 any more, and the graphics data is redirected to the graphics module 303, instead of GPU 302. Hence the north bridge 301 transmits the graphics data to the graphics module 303 to process through the connecter 306.

The processed data are transmitted from the graphics module 303 and passing through the connecter 306 and back to the north bridge 301, and then to a template memory (not shown), such as a frame buffer for GPU 302 or a main memory. GPU 302 gets the processed graphics data from the template memory and then displays it on LVDS panel 305 via LVDS channel 307. Since the LVDS channel 307 is employed to transport the data for the panel 305, and original VBIOS of GPU 302 has stored correct timing, resolution and relative information for LVDS panel 305. No matter what VBIOS of the graphic module 303 is, the processed data can be displayed on LVDS panel 305 correctly via LVDS channel 307.

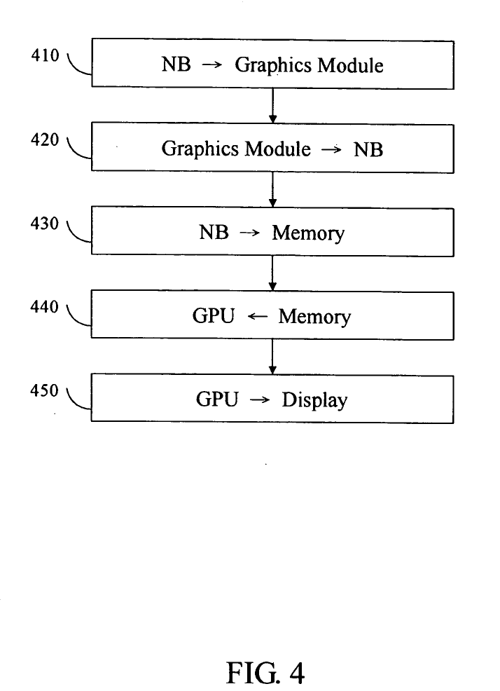

Referring to FIG. 4, it is the flow chart for processing the graphics data in accordance with the present invention. In step 410, the north bridge transmits the graphics data to the graphics module for processing. Next, in step 420, the graphics module transmits the processed data back to the north bridge. Next, in step 430, the north bridge transmits the processed data to a memory, such as a frame buffer or the main memory. Next, in step 440, the GPU gets the processed data from the memory. Next, in step 450, the GPU outputs the processed data to a display, such as an LVDS panel.

One skilled in the art will understand that the embodiment of the present invention as shown in the drawings and described above is exemplary only and not intended to be limiting.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. An architecture for a plug-in graphics module, comprising:
a graphic processing unit (GPU), capable of processing graphics data;
a connecter, capable of connecting a graphics module;
a bridge circuit, connected to the GPU and the connecter; and
a differential signal bus, electrically connected to the GPU;
wherein the bridge circuit is capable of transmitting a plurality of data to the graphics module, receiving a processed result from the graphics module, and transmitting the processed result to a memory device for the GPU to access the processed result, and then the GPU outputs the processed result to a panel through the differential signal bus when the graphics module is plugged in the connecter.

2. The architecture for a plug-in graphics module according to the claim 1, wherein the GPU is integrated in the bridge circuit.

3. The architecture for a plug-in graphics module according to the claim 1, wherein the GPU is separate from the bridge circuit.

4. The architecture for a plug-in graphics module according to the claim 1, the bridge circuit is a chipset.

5. A method for processing signals in an architecture for a plug-in graphics module, comprising:
a north bridge transmitting a plurality of data to a graphics module to generate a processed result;
the graphics module transmitting the processed result back to the north bridge;
the north bridge transmitting the processed result to a memory;
the GPU obtaining the processed result from the memory; and
the GPU outputting the processed result to a display.
